(19) United States
(12) Patent Application Publication
(10) Pub. No.: US 2025/0170931 A1
(43) Pub. Date: May 29, 2025

(54) FITTING FOR A VEHICLE SEAT, AND VEHICLE SEAT

(71) Applicant: Adient US LLC, Plymouth, MI (US)

(72) Inventors: Karthikeyan M. SUBRAMANIAN, Leverkusen (DE); Eduard MÉRÉS, Skalica (SK); Ralf VOMBERG, Muelheim (DE); Grit SCHOLZ, Remscheid (DE); Kirubaharan ALBERT REGINOLD, Burscheid (DE); Balaji PARAMASIVAM, Leverkusen (DE)

(21) Appl. No.: 18/937,163

(22) Filed: Nov. 5, 2024

(30) Foreign Application Priority Data
Nov. 29, 2023 (DE) 10 2023 133 329.1

(51) Int. Cl. B60N 2/225; F16H 57/04

(52) U.S. Cl. CPC B60N 2/225; F16H 57/045

(57) ABSTRACT

A fitting for a vehicle seat may have a first fitting part having a toothed ring and a second fitting part having a gearwheel. The gearwheel may be in meshing engagement with the toothed ring, and the first fitting part and the second fitting part may be wobblingly rotatable relative to each other about an axis. An eccentric makes it possible to drive a relative rolling contact motion between the gearwheel and the toothed ring. The eccentric may have two wedge segments and at least one driver segment arranged between the wedge segments. The at least one driver segment may have at least one lubricant reservoir filled with a lubricant. A vehicle seat having the fitting is also provided.

### FIELD

The invention relates to a fitting for a vehicle seat, comprising a first fitting part having a toothed ring and a second fitting part having a gearwheel, the gearwheel being in meshing engagement with the toothed ring, and the first fitting part and the second fitting part being wobblingly rotatable relative to each other about an axis, in that an eccentric makes it possible to drive a relative rolling contact motion between the gearwheel and the toothed ring, the eccentric having two wedge segments and at least one driver segment arranged between the wedge segments. The invention additionally relates to a vehicle seat.

### BACKGROUND

WO 2005/077704 A2 discloses a fitting for a vehicle seat, comprising a first fitting part, a second fitting part in geared connection with the first fitting part, and an eccentric, defined by a driver ring and two wedge segments braced against each other, for driving a rolling contact motion of the second fitting part on the first fitting part. During the rolling contact motion, the driver ring slides along on a drawn collar of the fitting part adjacent to it. The driver ring has a driver segment mounted between the narrow sides of the wedge segments. The driver segment has an internal toothing, in which an external toothing of a driver bushing form-fittingly engages to drive the driver ring. The external toothing of the driver bushing completely closes the internal toothing of the driver segment, with the result that an encircling, circular-cylindrical surface for rotary mounting of the driver ring on an outside of the drawn collar is provided. There are no lubricant receiving means for this rotary bearing point.

WO 2012/110213 A2 discloses a fitting for a vehicle seat, comprising a first fitting part and a second fitting part which are rotatable relative to each other and which are in geared connection with each other by a toothed ring and a gearwheel meshing with the toothed ring, and comprising an eccentric, which is driven by a driver and revolves in the circumferential direction, for driving a relative rolling contact motion of gearwheel and toothed ring. The driver has a hub and a driver segment, which is mounted with play between the narrow sides of two wedge segments of the eccentric. The driver is formed in one piece. A radially inwardly facing surface of the driver segment slides along on a drawn collar of the adjacent fitting part. There are no lubricant receiving means for this contact surface.

DE 198 39 296 A1 discloses a preferred lubricant, in particular for above-described fittings for vehicle seats. The lubricant is optimized to avoid chatter vibrations and to minimize the coefficient of friction and the wear in such fittings.

### SUMMARY

The invention addresses the problem of improving a fitting of the type mentioned in the introduction, in particular of improving the storage and uniform distribution of lubricant inside the fitting throughout the service life and thereby reducing the wear of the fitting. In addition, the intention is to provide a vehicle seat comprising at least one fitting optimized in this way.

This problem is solved according to the invention by a fitting for a vehicle seat, comprising a first fitting part having a toothed ring and a second fitting part having a gearwheel, the gearwheel being in meshing engagement with the toothed ring, and the first fitting part and the second fitting part being wobblingly rotatable relative to each other about an axis, in that an eccentric makes it possible to drive a relative rolling contact motion between the gearwheel and the toothed ring, the eccentric having two wedge segments and at least one driver segment arranged between the wedge segments, the at least one driver segment having at least one lubricant reservoir filled with a lubricant.

Since the at least one driver segment has at least one lubricant reservoir filled with a lubricant, storage and uniform distribution of lubricant inside the fitting throughout the service life is provided and the wear of the fitting is thereby minimized.

The at least one lubricant reservoir may be partially filled with a lubricant. The at least one lubricant reservoir is preferably completely filled with a lubricant at the start of a service life of the fitting. During the service life of the fitting, lubricant can leave the lubricant reservoir in order to supply lubricant to the fitting, in particular to supply lubricant to a plain bearing between the at least one driver segment and at least one of the two fitting parts continuously over the service life.

The at least one driver segment may have a first contact surface. The at least one driver segment may have a first contact surface and a second contact surface. The at least one driver segment may be radially inwardly supportable and slidingly mounted on one of the two fitting parts by the first contact surface. The at least one driver segment may be radially outwardly supportable and slidingly mounted on the other one of the two fitting parts by the second contact surface.

The at least one driver segment may be radially inwardly supportable and slidingly mounted on a collar of the second fitting part by the first contact surface. The at least one driver segment may be radially outwardly supportable and slidingly mounted on a plain bearing bushing of the first fitting part by the second contact surface.

The first contact surface may have at least one opening, through which lubricant can leave the at least one lubricant reservoir. The second contact surface may have at least one opening, through which lubricant can leave the at least one lubricant reservoir.

The at least one lubricant reservoir may be formed by a depression in the first contact surface. The at least one lubricant reservoir may be formed by a depression in the second contact surface. The at least one lubricant reservoir may be formed by a respective depression in the first contact surface and in the second contact surface.

The depression may extend in the axial direction over the entire width of the at least one driver segment.

The eccentric may have exactly one driver segment. The eccentric may have exactly one driver segment with at least one lubricant reservoir. There is particularly effective distribution of the lubricant if the exactly one driver segment has exactly three lubricant reservoirs.

The eccentric may have two circumferentially spaced-apart driver segments. Compared to exactly one driver segment, this makes it possible to save on material and weight. Each of the two driver segments may have at least one lubricant reservoir. Each of the two driver segments preferably has exactly one lubricant reservoir.

The lubricant may be a lubricating grease, as is known for example from DE 198 39 296 A1. The lubricant may be a liquid lubricant. The lubricant may be a solid lubricant.

The problem is also solved by a vehicle seat comprising a seat part, a backrest and at least one fitting according to the invention, the backrest being inclination-adjustably connected to the seat part by the at least one fitting. Since the structural components of seat part and backrest are generally non-detachably welded to the respective associated fitting part, the service life of the vehicle seat is limited by the service life of the fitting. Therefore, the invention lengthens not only the service life of the fitting, but thus also the service life of the vehicle seat (compared to vehicle seats known from the prior art).

In summary and in other words, in the case of a fitting according to the invention, a driver, in particular a driver ring of the driver, in particular at least one driver segment of the driver ring, has at least one grease reservoir, in particular at least one slot filled with grease. Re-greasing, in particular of the driver ring, in particular in the region of a gearwheel, takes place with the grease stored in the slot throughout the service life of the fitting.

### FIGURES AND EMBODIMENTS OF THE INVENTION

### Description of the Figures

The invention is explained in more detail below on the basis of a fitting illustrated in FIG. 2 and known from the prior art and two advantageous exemplary embodiments illustrated in the further figures. However, the invention is not restricted to these exemplary embodiments. In the figures:

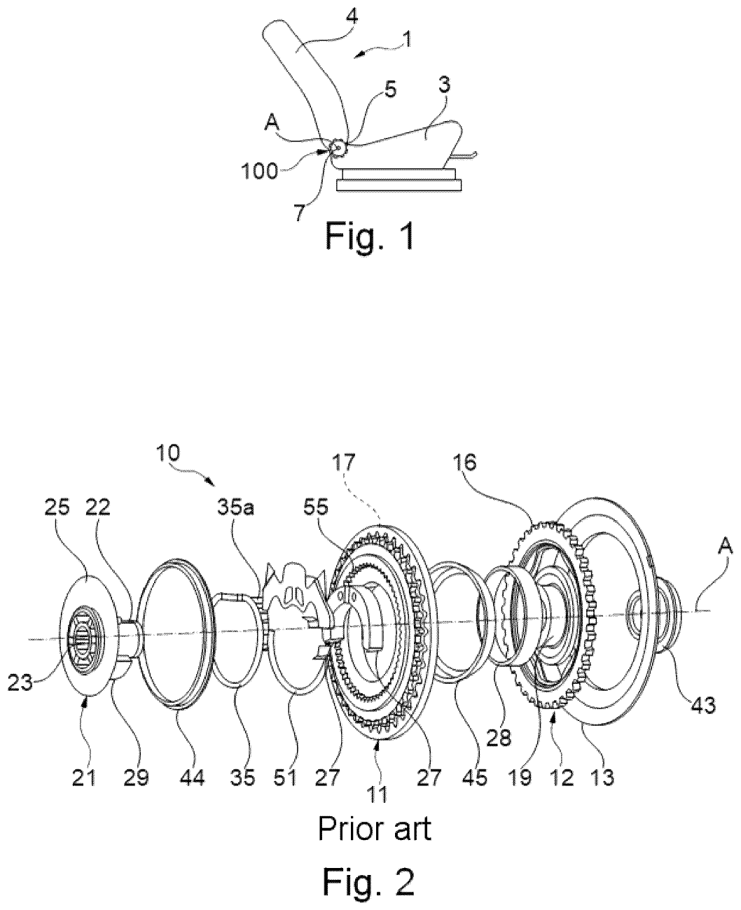

FIG. 1: shows a schematic illustration of a vehicle seat according to the invention,

FIG. 2: shows an exploded illustration of the fitting known from the prior art,

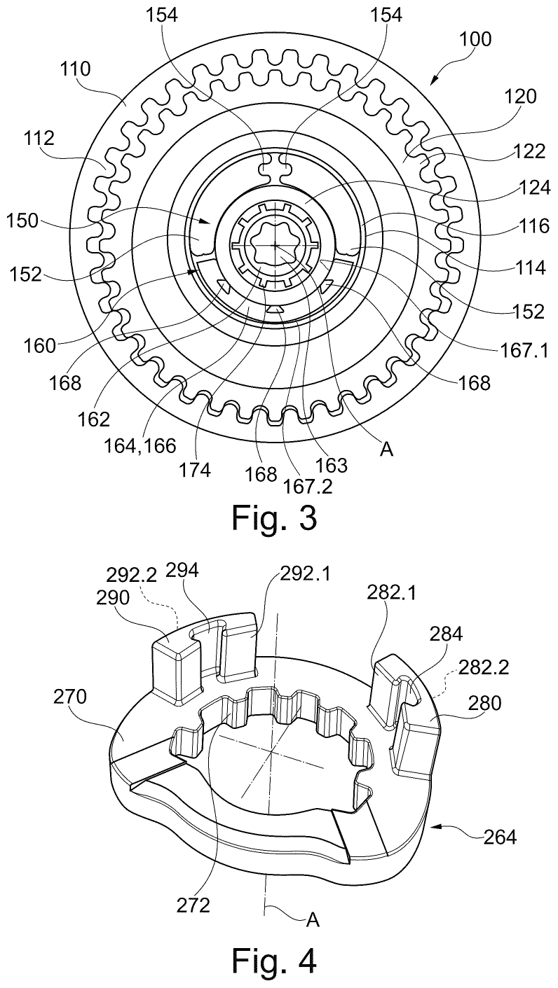

FIG. 3: shows a sectional illustration of a fitting according to the invention as per a first exemplary embodiment, and

FIG. 4: shows a driver ring of a fitting according to the invention as per a second exemplary embodiment.

### DETAILED DESCRIPTION

FIG. 1 shows a vehicle seat 1 according to the invention for a motor vehicle. The vehicle seat 1 has a seat part 3 and a backrest 4 which is adjustable in its inclination relative to the seat part 3. To adjust the inclination of the backrest 4, a drive shaft 7, which is arranged horizontally in the transition region between the seat part 3 and the backrest 4, is rotated manually, for example by a handwheel 5, or by motor, for example by an electric motor. On both sides of the vehicle seat 1, the drive shaft 7 engages in a respective fitting 100 according to the invention for conjoint rotation. The drive shaft 7 defines an axis A and the directional indications of a cylinder coordinate system that are used below. The radial direction is—as is conventional in cylinder coordinate systems—perpendicular to the axis A.

FIG. 2 shows an exploded illustration of a fitting 10 known from the prior art, which is described below for a better understanding of the fitting 100 according to the invention.

The fitting 10 known from the prior art has a first fitting part 11 and a second fitting part 12. The first fitting part 11 and the second fitting part 12 are wobblingly rotatable relative to each other about the axis A. The two fitting parts 11 and 12 can each approximately describe a circular disk shape. The two fitting parts 11 and 12 are composed of metal, in particular steel, which may be hardened at least in certain regions. For absorbing the axially acting forces, that is to say for holding the fitting parts 11 and 12 together axially, a clasp ring 13 is provided.

The clasp ring 13 is fixedly welded to an outer edge portion of the first fitting part 11. A radially inwardly facing edge portion of the clasp ring 13 engages over a radially outer edge region of the second fitting part 12, without interfering with a relative rotatability of the two fitting parts 11 and 12. The clasp ring 13 and the first fitting part 11 fixedly connected thereto thus clasp the second fitting part 12, which is movable relative to the clasp ring and to the first fitting part. In structural terms, the two fitting parts 11 and 12 together (with the clasp ring 13) form a disk-shaped unit.

While the vehicle seat 1 is being installed, the first fitting part 11 is fixedly connected to the structure of the backrest 4. The second fitting part 12 is fixedly connected to the structure of the seat part 3. However, the assignments of the fitting parts 11 and 12 may also be swapped, i.e. the first fitting part 11 can alternatively be connected to the seat part 3 and the second fitting part 12 can be correspondingly connected to the backrest 4. The fitting 10 lies in the force flow between the backrest 4 and the seat part 3.

The fitting 10 is designed as a geared fitting, in which the first fitting part 11 and the second fitting part 12 are connected to each other by a gear for adjusting and fixing, more precisely by an—in the present case self-locking—eccentric planetary gear, as described, for example, in DE 44 36 101 A1.

To construct the gear, exactly one externally toothed gearwheel 16 is formed on the second fitting part 12, and exactly one internally toothed toothed ring 17 is formed on the first fitting part 11, the gearwheel and the toothed ring intermeshing. The diameter of the addendum circle of the external toothing of the gearwheel 16 is smaller by at least one times the tooth height than the diameter of the dedendum circle of the internal toothing of the toothed ring 17. An appropriate difference in the number of teeth of the gearwheel 16 and the toothed ring 17 of at least one tooth allows the toothed ring 17 to perform a rolling contact motion on the gearwheel 16. The gearwheel 16 forms the radially outer edge of the second fitting part 12.

The second fitting part 12 has a collar 19, which is arranged concentrically with the gearwheel 16. The collar 19 is integrally formed as a drawn collar on the second fitting part 12 or is fastened as a separate sleeve to the second fitting part 12. A driver 21 is rotatably mounted in the collar 19 by a hub 22. The hub 22 of the driver 21 is provided centrally with a bore 23 for receiving the drive shaft 7. The profile of the bore 23 is designed to match the profile of the drive shaft 7, in the present case a splined shaft profile. Following its hub 22, the driver 21 has a cover disk 25, which is formed in one piece with the hub 22 and has a larger diameter than the hub 22.

Two wedge segments 27 are supported—with their curved inner surfaces—on the collar 19 and—with their curved outer surfaces—mount the first fitting part 11. For this purpose, a receptacle of the first fitting part 11 is lined with a plain bearing bushing 28 which is preferably pressed into place for conjoint rotation and on which the outer surfaces of the wedge segments 27 bear. The terms “support” and “mount” are not limited to a specific direction of the force flow through the fitting 10, since this direction depends on the installation of the fitting 10.

The driver 21 has—radially spaced apart from the hub 22—a driver segment 29 mounted with a clearance between the narrow sides of the wedge segments 27. The wedge segments 27, the wide sides of which face each other, receive with a respective recess a respective angled end finger 35a of an omega-shaped spring 35. The spring 35 acts upon the wedge segments 27 in the circumferential direction, in particular in order to push them apart, with the wide sides of the wedge segments 27 being able to be in contact with each other and act upon each other during an adjustment of the fitting 10. The driver 21 is mounted in the collar 19 and axially secured on the outside of the second fitting part 12 by a circlip 43. Provided on the outside of the first fitting part 11, between its radially outer edge and the cover disk 25, is a sealing ring 44, which is connected to the cover disk 25.

The wedge segments 27 (and the spring 35) form an eccentric, which in a continuation of the direction of its eccentricity presses the gearwheel 16 into the toothed ring 17 at an engagement point. When the (repeatedly) rotating drive shaft 7 is providing drive, a torque is transmitted to the driver 21 and, by the driver segment 29, to the eccentric, which rotates in the plain bearing bushing 28 with shifting of the direction of the eccentricity, as a result of which the engagement point of the gearwheel 16 in the toothed ring 17 shifts, and this presents as a wobbling rolling contact motion between gearwheel 16 and toothed ring 17, i.e. as a relative rotation with superimposed wobbling motion. The inclination of the backrest 4 is thereby infinitely variably adjustable between a plurality of use positions. The eccentricity brought about by the eccentric 16 revolves with the engagement point about the axis A, which also results in the name of eccentric planetary gear or wobble gear for the fitting 10.

The fitting 10 illustrated in FIG. 2 and known from the prior art is preferably manually driven. In terms of the structure and function of the gear, the fitting 10 corresponds to the fittings known from the prior art, which are preferably driven by self-lockingly designed geared motors.

To improve the dynamic operating behaviour of the fitting 10, in particular in the case of a manual drive, a blocking spring 51 is preferably provided as a blocking element, as disclosed for example in DE 195 48 809 C1. In the present case, the blocking spring 51 interacts with a locking toothing 55, which is formed on the first fitting part 11. The blocking spring 51, which is movably mounted over an axial projection of the plain bearing bushing 28, respectively blocks the wedge segments 27 in a non-driven state of the driver 21 (in that the blocking spring 51 blocks the spring 35 by bearing against the end finger 35a) and is released by the driven driver 21. In the blocking state, the blocking spring 51 form-fittingly engages in the locking toothing 55, with the result that the blocking spring 51 cannot rotate relative to the locking toothing 55. In the non-blocking state, the blocking spring 51 is disengaged from the locking toothing 55, with the result that the blocking spring 51 can rotate relative to the locking toothing 55. The blocking spring 51 does not roll in the locking toothing 55 in any state. The blocking spring 51 can be omitted if the fitting is operated with a self-lockingly designed geared motor.

FIG. 3 shows a sectional illustration of a fitting 100 according to the invention as per a first exemplary embodiment. The fitting 100 corresponds in terms of its structure and its function to the fitting 10, known from the prior art, that is illustrated in FIG. 2 and described above, unless described otherwise below.

The fitting 100 has a first fitting part 110 and a second fitting part 120, which are rotatable relative to each other about the axis of rotation A in a manner described in more detail below, wherein a wobbling motion is superimposed on the rotational movement. The two fitting parts 110 and 120 can each approximately describe a circular disk shape. The two fitting parts 110 and 120 are preferably composed of metal, in particular steel, which may be hardened at least in regions. For absorbing the axially acting forces, that is to say for holding the two fitting parts 110 and 120 together axially, a clasp ring, not illustrated in FIG. 3, is provided.

The clasp ring is fixedly connected to one of the two fitting parts 110, 120, in the present exemplary embodiment to the first fitting part 110. A radially inwardly facing, circumferential edge region is used for the clasp ring to engage over the other of the two fitting parts 110, 120 which is movable relative thereto, here the second fitting part 120, radially on the outside without interfering with the wobbling relative rotational movement of the two fitting parts 110 and 120 with respect to each other. The clasp ring and the first fitting part 110 or second fitting part 120 fixedly connected thereto thus clasp the other one of the two fitting parts 110, 120, which is movable relative to the clasp ring and to the first fitting part. In structural terms, the two fitting parts 110, 120 together with the clasp ring form a disk-shaped unit.

The fitting 100 is designed as a geared fitting, in which the first fitting part 110 and the second fitting part 120 are connected to each other by a gear for adjusting and fixing, more precisely by an—in the present case self-locking—eccentric planetary gear, as described, for example, in DE 101 44 840 A1. To construct the gear, an internally toothed toothed ring 112 is formed on the first fitting part 110, and an externally toothed gearwheel 122 is formed on the second fitting part 120, the toothed ring and the gearwheel intermeshing.

One of the two fitting parts 110, 120, in the present case the second fitting part 120, has a collar 124. The collar 124 is configured to be concentric with the gearwheel 122. The collar 124 can be formed as a drawn collar on the second fitting part 120 (that is, formed in one piece) or fastened thereto as a separate sleeve.

Two curved wedge segments 152 each have a curved inner surface and a curved outer surface. The two wedge segments 152 are supported with the curved inner surfaces on the collar 124. The wedge segments 152 use the curved outer surfaces for the mounting of the other of the two fitting parts 110, 120, in the present case the first fitting part 110. For this purpose, a receiving opening of the last-mentioned fitting part (in the present case a receiving opening 114 of the first fitting part 110) is lined with a plain bearing bushing 116 which is preferably pressed into place for conjoint rotation and on which the outer surfaces of the two wedge segments 152 bear.

A respective first end of each wedge segment 152 has a surface extending approximately in the radial direction, hereinafter referred to as wide side. An end of each wedge segment 152 lying opposite in the circumferential direction of the wide side has a surface also extending approximately in the radial direction, hereinafter referred to as narrow side. The wide side is larger in the radial direction than the narrow side.

The wedge segments 152, the wide sides of which face each other, receive with a respective recess 154 a respective angled end finger of a biased and for example omega-shaped spring, which is not illustrated in the figures. This spring acts upon the wedge segments 152 in the circumferential direction in order to push them apart, with the wide sides of the wedge segments 152 being able to be in contact with each other and act upon each other during the adjustment of the fitting 100.

As previously described, the drive shaft 7 is rotatable about the axis of rotation A to adjust the angle of inclination of the backrest 4 about the axis of rotation A. A driver 160 is used to transmit the rotational movement of the drive shaft 7 to an eccentric 150 having the two wedge segments 152. The driver 160 has a driver hub 162 and a driver ring 164 connected to the driver hub 162 for conjoint rotation, in particular via corresponding toothings. In the present case, the driver 160 is formed in two parts by the driver hub 162 and the driver ring 164 being separately formed components which are connected to each other for conjoint rotation, in particular in a form-fitting manner by a plug-in toothing. The driver 160 is preferably composed of plastic.

The driver ring 164 has a driver segment 166, which (with play, as viewed in the circumferential direction) is arranged between the narrow sides of the wedge segments 152. The driver segment 166 preferably has the shape of a hollow cylinder segment. The driver segment 166 is arranged radially between the collar 124 and the plain bearing bushing 116.

The driver segment 166 has a first contact surface 167.1 and a second contact surface 167.2. The first contact surface 167.1 faces radially inwards. The second contact surface 167.2 faces radially outwards. The driver segment 166 is radially inwardly supportable and slidingly mounted on the collar 124 by the first contact surface 167.1. The driver segment 166 is radially outwardly supportable and slidingly mounted in the plain bearing bushing 116 of the first fitting part 110 by the second contact surface 167.2 of the driver segment 166.

The driver segment 166 has three lubricant reservoirs 168 each filled with a lubricant. In the present case, the lubricant reservoirs 168 are each in the form of a depression in the driver segment 166. The lubricant reservoirs 168 are formed circumferentially equidistantly from one another in the driver segment 166. At least one of the lubricant reservoirs 168 can extend in the axial direction in each case over the entire width of the driver segment 166.

The lubricant reservoirs 168 are each completely filled with a lubricant, in particular a grease, at the start of a service life of the fitting 100. The lubricant reservoirs 168 each have an opening, through which lubricant can leave the lubricant reservoirs 168. During the service life of the fitting 100, lubricant continuously leaves the lubricant reservoirs 168 and lubricates the plain bearing point between the first contact surface 167.1 of the driver segment 166 and the collar 124 of the second fitting part 120.

The opening of each lubricant reservoir 168 is in the first contact surface 167.1. The opening of each lubricant reservoir 168 is smaller in the circumferential direction than the maximum extent of the lubricant reservoir 168 in the circumferential direction.

The eccentric 150 is formed by the two wedge segments 152 and the driver segment 166. The eccentric 150 in the present case has an approximately circular outer contour, which is offset by an eccentricity with respect to the axis of rotation A. The eccentric 150 presses the toothings of the gearwheel 122 and of the toothed ring 112 in the direction of the eccentricity maximally deeply into each other at an engagement point E. The depth of the tooth engagement decreases in the circumferential direction on both sides of the engagement point E. In a region radially opposite the engagement point E, the teeth of gearwheel 122 and toothed ring 112 are completely disengaged and are at the greatest possible distance from each other.

The driver hub 162 of the driver 160 is mounted rotatably in the collar 124 about the axis of rotation A. The driver hub 162 is provided centrally with a bore 163 for receiving the drive shaft 7. The profile of the bore 163 is designed to match the profile of the drive shaft 7, in the present case a splined shaft profile. The driver hub 162 also has a cover disk, not illustrated in FIG. 3, around the circumference. An outside diameter of the cover disk is larger than an inside diameter of the collar 124. On the outside of the fitting part having the plain bearing bushing 116 (in the present case the first fitting part 110), a sealing ring, for example made of rubber or soft plastic, is provided between its radially central region and the cover disk and is connected, in particular clipped, to the cover disk.

The driver 160 is axially secured on the outside of the fitting part having the collar 124 by a preferably clipped-on circlip 174. The circlip 174 extends in the axial direction along a part of the driver hub 162 such that the driver hub 162 does not lie directly against the inside of the collar 124, but is mounted in the collar 124 with the interposition of the circlip 174 (and the driver 160 is thereby mounted on the second fitting part 120).

During driving by the drive shaft 18 which rotates (repeatedly) about the axis of rotation A, a torque is first of all transmitted in the manner described in more detail below to the driver 160 and then by the driver segment 166 to the wedge segments 152 of the eccentric 150. The eccentric 150 rotates relative to the two fitting parts 110, 120, as a result of which shifting of the direction of the eccentricity and thus a circumferential shifting of the engagement point E takes place, which results in a wobbling rolling contact motion of the toothings of toothed ring 112 and gearwheel 122. The inclination of the backrest 4 is thereby infinitely variably adjustable between a plurality of use positions.

FIG. 4 shows a driver ring 264 of a driver of a fitting according to the invention as per a second exemplary embodiment. The fitting of the second exemplary embodiment corresponds in terms of its structure and its function to the fitting 100 illustrated in FIG. 3 and described above, unless described otherwise below.

The driver ring 264 has a baseplate 270. The baseplate 270 is largely annular and, radially inwards, has a toothing 272 for connection to a driver hub, not illustrated in FIG. 4, for conjoint rotation.

The driver ring 264 also has two driver segments 280, 290, which protrude from the baseplate 270 in the axial direction and are spaced apart in the circumferential direction. The two driver segments 280, 290 preferably have the shape of a hollow cylinder segment. The driver segments 280, 290 are each arranged radially between a collar of a first fitting part and a plain bearing bushing of the first fitting part. As viewed in the circumferential direction, the two driver segments 280, 290 are arranged with play between the narrow sides of two wedge segments of the fitting and, together with the wedge segments, form an eccentric.

The two driver segments 280, 290 are preferably identically formed, but arranged offset from one another in the circumferential direction. Owing to the identical design, only a first driver segment 280 of the two driver segments 280, 290 is described in detail below. The description, however, also applies to the second driver segment 290 of the two driver segments 280, 290.

The first driver segment 280 has a first contact surface 282.1 and a second contact surface 282.2. The first contact surface 282.1 faces radially inwards. The second contact surface 282.2 faces radially outwards. The first driver segment 280 is radially inwardly supportable and slidingly mounted on the collar by the first contact surface 282.1. The first driver segment 280 is radially outwardly supportable and slidingly mounted in the plain bearing bushing of the first fitting part by the second contact surface 282.2 of the first driver segment 280.

The first driver segment 280 has a lubricant reservoir 284 filled with a lubricant. In the present case, the lubricant reservoir 284 is in the form of a depression in the first driver segment 280. The lubricant reservoir 284 is formed circumferentially in the middle of the first driver segment 280. The lubricant reservoir 284 can extend in the axial direction in each case over the entire width of the first driver segment 280.

The lubricant reservoir 284 is in each case completely filled with a lubricant, in particular a grease, at the start of a service life of the fitting. The lubricant reservoir 284 has an opening, through which lubricant can leave the lubricant reservoir 284. During the service life of the fitting, lubricant continuously leaves the lubricant reservoir 284 and lubricates the plain bearing point between the first contact surface 282.1 of the driver segment 280 and the collar of the second fitting part.

The opening of the lubricant reservoir 284 is in the first contact surface 282.1. The opening of the lubricant reservoir 284 is smaller in the circumferential direction than the maximum extent of the lubricant reservoir 284 in the circumferential direction.

Owing to the identical design of the two driver segments 280, 290, the description given above likewise applies to a first contact surface 292.1, a second contact surface 292.2 and a lubricant reservoir 294 of the second driver segment 290.

In deviations of the exemplary embodiments, it is also possible for the wedge segments and/or the collar of the second fitting part to have lubricant reservoirs. It is also conceivable for exclusively the wedge segments and/or the collar of the second fitting part to have corresponding lubricant reservoirs, although it is more complex from a manufacturing technology perspective to provide the lubricant reservoirs in the wedge segments and/or the collar. The exemplary embodiments described above are therefore preferred.

### LIST OF REFERENCE SIGNS

1 Vehicle seat
3 Seat part
4 Backrest
5 Handwheel
7 Drive shaft
10 Fitting (prior art)
11 First fitting part
12 Second fitting part
13 Clasp ring
16 Gearwheel
17 Toothed ring
19 Collar
21 Driver
22 Hub
23 Bore
25 Cover disk
27 Wedge segment
28 Plain bearing bushing
29 Driver segment
30 Spring
35a End finger
43 Circlip
44 Sealing ring
51 Blocking spring
55 Locking toothing
100 Fitting (first exemplary embodiment according to the invention)
110 First fitting part
112 Toothed ring
114 Receiving opening
116 Plain bearing bushing
120 Second fitting part
122 Gearwheel
124 Collar, drawn collar
150 Eccentric
152 Wedge segment
154 Cutout
160 Driver
162 Driver hub
163 Bore
164 Driver ring
166 Driver segment
167.1 First contact surface
167.2 Second contact surface
168 Lubricant reservoir
174 Circlip
264 Driver ring
270 Baseplate
272 Toothing
280 First driver segment
282.1 First contact surface
282.2 Second contact surface
284 Lubricant reservoir
290 Second driver segment
292.1 First contact surface
292.2 Second contact surface
294 Lubricant reservoir
A Axis of rotation

1. A fitting for a vehicle seat, comprising a first fitting part having a toothed ring and a second fitting part having a gearwheel, the gearwheel being in meshing engagement with the toothed ring, and the first fitting part and the second fitting part being wobblingly rotatable relative to each other about an axis, in that an eccentric makes it possible to drive a relative rolling contact motion between the gearwheel and the toothed ring, the eccentric having two wedge segments and at least one driver segment arranged between the wedge segments, characterized in that the at least one driver segment has at least one lubricant reservoir filled with a lubricant.

2. The fitting according to claim 1, characterized in that the at least one lubricant reservoir at the start of a service life of the fitting is completely filled with a lubricant and during the service life of the fitting lubricant can leave the lubricant reservoir.

3. The fitting according to claim 1, characterized in that the at least one driver segment has a first contact surface and a second contact surface, the at least one driver segment being radially inwardly supportable and slidingly mounted on one of the two fitting parts by the first contact surface, and radially outwardly supportable and slidingly mounted on the other one of the two fitting parts by the second contact surface.

4. The fitting according to claim 3, characterized in that the at least one driver segment is radially inwardly supportable and slidingly mounted on a collar of the second fitting part by the first contact surface.

5. The fitting according to claim 4, characterized in that the first contact surface and/or the second contact surface has an opening, through which lubricant can leave the at least one lubricant reservoir.

6. The fitting according to claim 5, characterized in that the at least one lubricant reservoir is formed by a depression in the first contact surface and/or a depression in the second contact surface.

7. The fitting according to claim 6, characterized in that the depression extends in the axial direction over the entire width of the at least one driver segment.

8. The fitting according to claim 1, characterized in that the eccentric has exactly one driver segment, the driver segment having the at least one lubricant reservoir.

9. The fitting according to claim 1, characterized in that the eccentric has two circumferentially spaced-apart driver segments, each of the two driver segments having exactly one lubricant reservoir.

10. A vehicle seat comprising a seat part, a backrest and at least one fitting according to claim 1, the backrest being inclination-adjustably connected to the seat part by the at least one fitting.
